(19) United States
(12) Patent Application Publication
(10) Pub. No.: US 2024/0308910 A1
(43) Pub. Date: Sep. 19, 2024

(54) LIGHTWEIGHT CORE-SHELL AGGREGATE AND CONCRETE

(71) Applicant: Nano and Advanced Materials Institute Limited, Hong Kong (HK)

(72) Inventors: Shuai ZOU, Hong Kong (HK); Chung Kong CHAU, Hong Kong (HK); Yong FAN, Hong Kong (HK); Man Lung SHAM, Hong Kong (HK)

(21) Appl. No.: 18/604,441

(22) Filed: Mar. 13, 2024

Related U.S. Application Data
(60) Provisional application No. 63/490,108, filed on Mar. 14, 2023.

(51) Int. Cl. C04B 18/08; C04B 18/02; C04B 20/10; C04B 20/12; C04B 111/40

(52) U.S. Cl. CPC C04B 18/082; C04B 18/027; C04B 20/1007; C04B 20/12; C04B 2111/40; C04B 2201/20

(57) ABSTRACT

High-strength, lightweight core-shell aggregates are formed from waste materials. The aggregates include porous core materials which may be one or more of perlite, vermiculite, cenospheres, expanded polystyrene, or biochar. Formed on the core materials is at least one layer of shell material which includes one or more of GGBS, fly ash, recycled concrete powder, recycled glass powder, or biochar powder. The high-strength, lightweight core- shell aggregates have a loose bulk density less than approximately 980 kg/m³, a crushing strength higher than approximately 4 MPa, a water absorption of less than 20%, and a carbon emission of approximately 181 kgCO₂eq/t or less. Lightweight concrete is formed by incorporating the high-strength, lightweight core-shell aggregates with cement to create concrete with a density of 1900 kg/m³ or less.

### CROSS-REFERENCE TO RELATED APPLICATIONS:

The present application claims priority to provisional U.S. Patent Application No. 63/490, 108 filed Mar. 14, 2023, the disclosure of which is incorporated by reference herein.

### FIELD OF THE INVENTION:

The present invention relates to improved artificial aggregates that are lightweight as well as high strength and, more particularly, to artificial lightweight aggregates having a core-shell structure formed by cold bonding.

BACKGROUND:

Urbanization has been driving a surge in demand for construction sand and gravel (S&G). Globally, humans consume 50 billion metric tons of S&G per year, equivalent to 18 kg per person per day. Since the consumption rate of S&G exceeds its natural renewal rate, its harvesting inevitably impacts the environment, which poses a sustainability challenge for the 21st century. Meanwhile, carbon neutrality is another challenge of the 21st century. Since the building and construction sector accounts for 39% of global carbon emissions, reducing the S&G utilization and carbon emission during buildings' construction and operation has substantial consequences for climate change. As a result, artificial lightweight aggregates (ALAs) and structural lightweight aggregate concrete have been attracting increasing attention. ALAs can be used to replace S&G in producing concrete to reduce its consumption. Further, structural lightweight aggregate concrete typically has a better thermal performance than normal concrete, reducing energy consumption during building operation.

However, the commonly-available ALAs (such as expanded perlite, expanded shale, and lightweight expanded clay aggregate) are produced by energy-intensive sintering processes. Comparatively, cold-bonding technology requires less energy for artificial aggregate production. This is because 1) the cold bonding process is conducted at room temperature without heating, and the strength of the produced cold-bonded aggregates (CBAs) is sourced from the hydration of cementitious materials; 2) industrial wastes can be easily incorporated into the CBAs by a pelletizing process to lower its carbon emission. There are many studies about CBAs based on cold-bonding technology. For example, previous studies have utilized a series of waste materials, including car fluff, cement kiln dust, coal fly ash, sludge wastewater and desulfurization treatment, granulated blast furnace slag (GGBS), and incineration bottom ash for CBAs production, obtaining CBAs with a particle density of up to 2000 kg/m³ while the crushing strength (CS) was less than 6.9 MPa. Other studies have reported the recycling of GGBS, rice husk ash, and coal fly ash for producing CBAs by binding with cement or geopolymerization with alkali- activators, which achieved the highest CS of 11.28 MPa with corresponding loose bulk density (LBD) of 1028 kg/m³. Other studies on the CBAs derived from the recycling of municipal solid waste incineration bottom ash as well as coal fly ash, paper sludge ash, and washing aggregate sludge. CBAs with LBD ranging from 942 kg/m³ to 980 kg/m³ and CS in the range of 4.3 MPa to 7.5 MPa have been produced. Other studies on CBAs utilizing wastes or other by-products include iron ore fines, low-calcium bottom ash, sand sludge, zeolitic rocks, construction and demolition wastes etc.

However, previous aggregates from recycled wastes have been formed from cold bonding without consideration for the aggregate density and strength; as a result, the prior art CBAs are often high density and low strength. Thus, there is a need in the art for improved artificial aggregates that are lightweight as well as high strength. Such lightweight aggregates could be used to form lightweight and high strength concrete with reduced carbon footprint.

### SUMMARY OF THE INVENTION:

Previously developed cold-bonded aggregates are typically solid structures with a comparatively high density. These solid aggregates are not sufficiently lightweight or high strength for developing structural lightweight concrete. Facing the issues of sand and gravel shortage and carbon emission of buildings' construction and operation, the need for high-strength lightweight concrete for cost-effective and energy-efficient building construction drives the need to develop high-strength lightweight aggregates. Thus, the present invention uses the low-temperature advantages of cold-bonding technology to develop

low-carbon and high-strength artificial lightweight aggregate (LHALA). In particular, core-shell aggregates (CSA) formed using cold-bonding technology are provided in which lightweight materials are used as a low-density core material for lowering the density, while the strength of the shell obtained by hydration and/or pozzolanic reaction can be designed to provide good bearing capacities.

In one aspect, the present invention provides high-strength, lightweight core-shell aggregates from waste materials. The aggregates include porous core materials which may be one or more of perlite, vermiculite, cenospheres, expanded polystyrene, or biochar. In particular, large sized cenosphere cores may be used. Formed on the core materials is at least one layer of shell material which includes one or more of GGBS, fly ash, recycled concrete powder, recycled glass powder, or biochar powder. The high-strength, lightweight core-shell aggregates have a loose bulk density less than approximately 980 kg/m3, a crushing strength higher than approximately 4 MPa, a water absorption of less than 20%, and a carbon emission of approximately 181 kgCO2eq/t or less.

The present invention also provides a method of making high-strength, lightweight core-shell aggregates from waste materials. Core materials, particularly large-size cenospheres are mixed with one or more shell materials selected from GGBS, fly ash, recycled concrete powder, recycled glass powder, OPC, or biochar powder. The core and shell materials are mixed by rotation in a pelletizer. A hydrating material selected from one or more of water, water glass, or aqueous alkali is added to form hydrated, pelletized, core-shell aggregates.

Following the pelletizing, the formed core-shell aggregates may be cured, particularly in a carbon dioxide-rich atmosphere.

Optionally, additional shell layers may be added that include one or more of GGBS,

fly ash, recycled concrete powder, recycled glass powder, OPC, or biochar.

### BRIEF DESCRIPTION OF THE DRAWINGS:

FIG. 1 depicts a high-strength artificial lightweight aggregate of the present invention.

FIG. 2 depicts lightweight concrete including the high-strength artificial lightweight aggregate of FIG. 1.

FIG. 3 schematically depicts a core-shell aggregate with a reactive surface layer formed thereon.

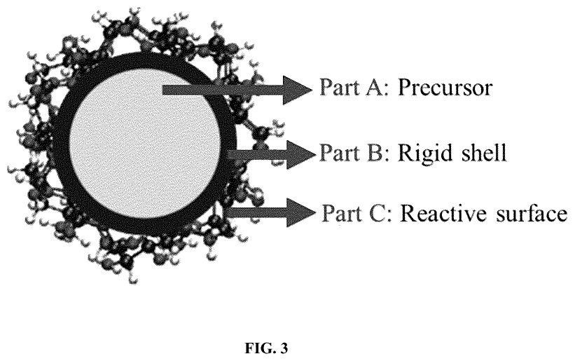

FIG. 4 is a graph depicting the effect of using GGBS in the shell material on the crushing strength of the formed aggregate.

FIG. 5 graphically depicts the embodied COE for producing 1 ton of CSA with 0-80% GGBS in the shell.

FIG. 6 is a photograph depicting starting materials, mixing, pelletizing and formed aggregates.

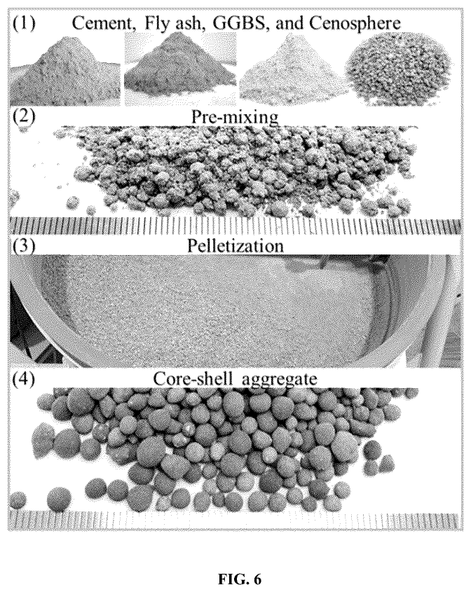

FIG. 7 is a photograph of large size cenospheres that may be used as core materials in the aggregates of the present invention.

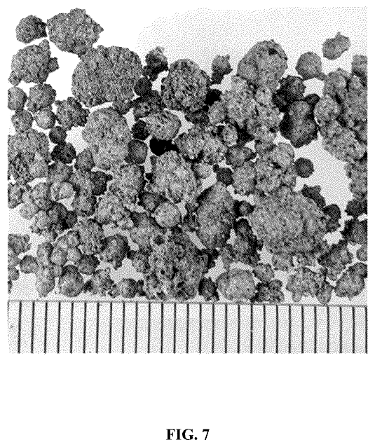

FIG. 8 shows the scope of carbon footprint assessment which is divided into material manufacturing, transportation, and aggregate production (pelletization).

### DETAILED DESCRIPTION:

The present invention uses the low-temperature advantages of cold-bonding technology to develop low-carbon and high-strength artificial lightweight aggregate (LHALA). In particular, core-shell aggregates (CSA) formed using cold-bonding technology are provided in which lightweight materials are used as a low-density core material for lowering the density, with a strong shell obtained by hydration and/or pozzolanic reaction to provide good bearing capacities.

In one aspect, cenosphere materials are used as core materials. Cenospheres are produced as a by-product of coal combustion in thermal power plants and are characterized as being both lightweight and strong due to their hollow sphere morphology. They are composed primarily of silica and alumina coal combustion residues and have insulating properties. Their density is on the order of 0.4-0.8 g/cm³. In the present invention, the size of the cenospheres employed ranges from about 20 to 5000 micrometers (μm), with most falling between 50 and 300 μm. While smaller size cenospheres have been used in other applications as fillers and in production of insulating materials, the use of large size cenospheres (more than 1 mm) is not widespread as these cenospheres are lower in strength and higher in water absorption compared with natural and artificial aggregates. However, due to their large particle size and lightweight features, larger size cenospheres (LSC) may be used with cold-bonding technology to produce CSA with desirable density and strength.

The novel core-shell structure is formed via cold-bonding, creating the low-carbon and high-strength artificial lightweight aggregates of the present invention. The core-shell structure is created by pelletizing the cenosphere core with cementitious materials that form the shell. In addition to cenospheres, the lightweight cores may be made from other porous materials. That is the lightweight cores may be made of one or more of of perlite, vermiculite, cenospheres, expanded polystyrene, or biochar.

The porous core and rigid shell ensure that aggregates have both lightweight and high-strength features. Solid wastes such as fly ash (FA) and GGBS (ground granulated blast furnace slag) may be used together with cement (OPC-ordinary Portland Cement) as the shell materials to reduce the carbon footprint of the formed aggregates. Other shell materials include recycled concrete powder, recycled glass powder, or biochar powder.

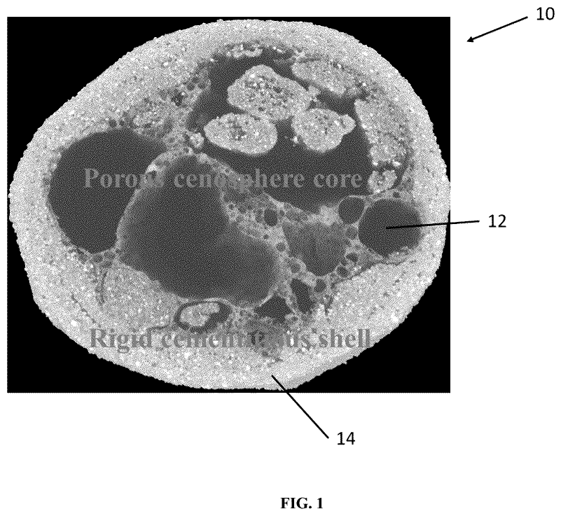

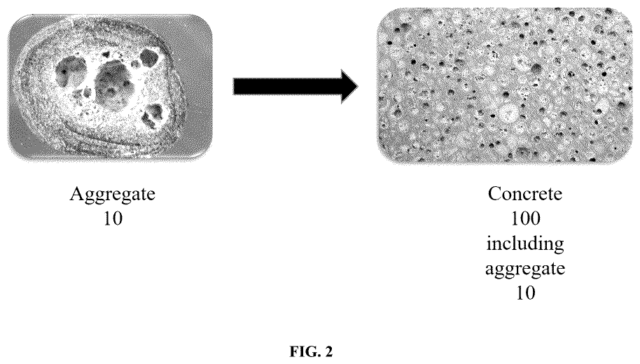

A cross-section of a formed aggregate is depicted in FIG. 1. In FIG. 1, aggregate 10 includes a porous cenosphere-based core 12 surrounded by a rigid cementitious shell 14. The shell may be a multilayer shell in which further layers are formed from GGBS, fly ash, cenospheres, recycled concrete powder, recycled glass powder, OPC, or biochar powder. In general, the shell layer(s) includes approximately 10-20% by mass of OPC with the remaining 80-90% by mass being one or more of the remaining shell materials. Typical aggregates formed by the cold bonding process range from approximately 2.36 mm to 30 mm as determined by the shell thickness. The thickness of the shell is determined by the shell/core ratio of the raw materials used for pelletization. Therefore, a range of desired sizes may be formed depending upon the desired aggregate application/final product. As seen in FIG. 2, lightweight concrete may be formed using the high-strength, lightweight core-shell aggregates of FIG. 1. Depending on the selected amounts of aggregates, the lightweight concrete can achieve a density of 1900 kg/m³\ or less, that is, the density point for forming lightweight concrete. This density may be attained by replacing 50% of the natural aggregate with the engineered lightweight aggregate of the present invention. Further reduction in density can be achieved with a higher replacement ratio.

The cold bonding process of the present invention is a low-carbon process as it is performed at ambient temperatures as compared with conventional high-temperature sintering processes.

To make the high-strength, lightweight aggregates, the porous core materials (perlite, vermiculite, cenospheres, expanded polystyrene, biochar or mixtures thereof) are mixed with one or more shell materials (GGBS, fly ash, recycled concrete powder, recycled glass powder, OPC, or biochar powder). The core and shell materials are mixed in a rotating mixer. Alternatively, the core materials are hydrated prior to adding the shell materials. The hydrating material may be water, water glass, or aqueous alkali. The hydrating materials may be added following mixing. The hydrated mixture is pelletized and cured to form the core-shell aggregates. The curing may be performed in a carbon dioxide-rich atmosphere. Curing in a carbon dioxide-rich atmosphere helps to create a reactive shell surface. Optionally, a second shell layer (or further layers) may be made from one or more of GGBS, fly ash, recycled concrete powder, recycled glass powder, OPC, or biochar.

Note that all the processes involved and the raw materials including pre-mixing, pelletization, and aggregate formation are low-carbon emission processes. For example, the core material is a “green” recycled waste material. When using large size cenospheres, a waste product of coal combustion, these larger cenospheres typically are rejected from other filler-type applications. The shell materials are also “green” recycled waste materials in that use of GGBS in high amounts. Fabrication by cold-bonding and pelletization is energy-saving compared with prior art sintering techniques. By designing the shell/core ratio and the strength of the shell, the aggregates can be produced with lightweight and high strength at the same time.

The physical properties such as loose bulk density, crushing strength, and 24 hour water absorption (WA) of the aggregates are evaluated in the Examples below. Factors affecting the aggregate properties were also analyzed. A carbon footprint assessment of the aggregates was also conducted to compare with the common commercially available artificial lightweight aggregates.

### EXAMPLES

### Example 1

Core and shell materials are set forth in Table 1 (cenosphere core and OPC cement shell). Aggregate formation was formed according to the following steps: 1) the raw core and shell materials were firstly pre-mixed in the pelletizer (diameter: 100 cm, depth : 25 cm, and tilting angle: 45°) under uniform rotation (15 rpm) for 2 minutes; 2) Water was sprayed on the materials during the following 15 minutes continuous rotation of the pelletizer until materials were wetted; 3) An additional 3 minutes rotation after spraying of water was performed for the further compaction of the pelletized fresh aggregate; 4) the pelletized fresh aggregate was cured under ambient atmospheric conditions and temperature/humidity for further testing. Third step: the performance of the developed aggregate was compared to commercial artificial lightweight aggregates in Table 2. The results showed that the core-shell structure design with cenosphere core of attained much higher strength efficiency (ratio of strength to density) than the commercial artificial lightweight aggregate.

TABLE 1
Mix proportion of high-performance lightweight core-shell aggregate/ton

| | Core | Shell | | |
|---|---|---|---|---|
| | materials (kg) | material (kg) | | Curing |
| Mix | Cenosphere | Cement | Water (kg) | condition |
| M1 | 95 | 750 | 155 | Unsealing |

TABLE 2
Comparison between aggregates of Example 1 and commercial
artificial lightweight aggregates

| | Expanded | | Expanded | |
|---|---|---|---|---|
| Key Criteria | perlite | Sintered clay | shale | HLCSA |
| Lose bulk | 80.5 | 316 | 607 | 838 |
| density (kg/m³) | | | | |
| Crushing | 0.135 | 1.132 | 3.291 | 6.93 |
| strength (MPa) | | | | |
| Strength | 1677 | 3582 | 5422 | 8270 |
| efficiency | | | | |
| (Pa · m³/kg) | | | | |

### Example 2

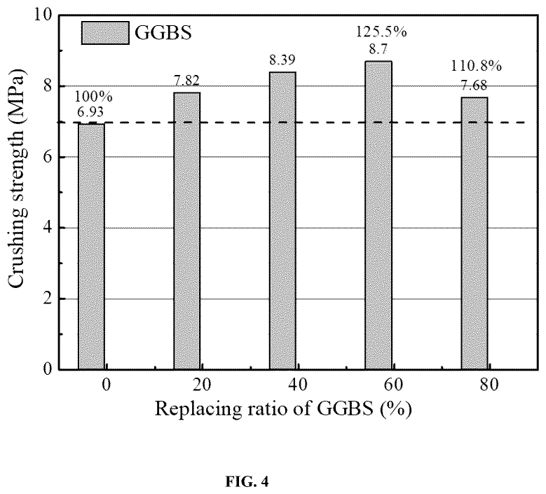

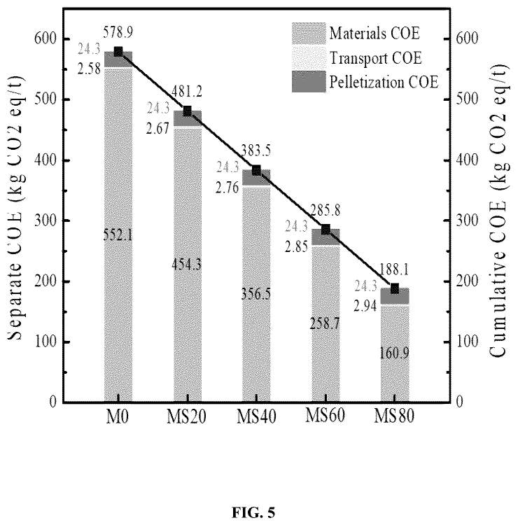

The composition of Example 1 was varied by replacing the cement (OPC) with 20%-80% GGBS, as shown in Table 3; Second step: aggregate fabrication with the following steps: 1) the raw core and shell materials were firstly pre-mixed in the pelletizer (diameter: 100 cm, depth: 25 cm, and tilting angle: 45°) under uniform rotation (15 rpm) for 2 minutes; 2) Water was sprayed on the materials during the following 15 minutes continuous rotation of the pelletizer; 3) Additional 3 minutes rotation after spraying of water for the further compaction of the pelletized fresh aggregate; 4) the pelletized fresh aggregate was cured under ambient conditions (denoted as “unsealing” conditions indicating that the curing is in open air) for further testing. Third step: the performance and carbon emission of the developed aggregate with different GGBS contents were shown in FIGS. 4 and 5. The results showed that replacing OPC with 80% GGBS for the shell material improves the crushing strength of the developed core-shell aggregate from 6.93 MPa to 7.68 MPa while substantially reducing the carbon emission to be 188 kgCO₂eq/t. This carbon emission is much lower than the carbon emission of commercial artificial lightweight aggregates such as expanded perlite, sintered clay.

TABLE 3
Mix proportion of HLCSA with different GGBS contents /ton

| | Core materials (kg) | Shell material (kg) | | Water | Curing |
|---|---|---|---|---|---|
| Mix | Cenosphere | Cement | GGBS | (kg) | condition |
| MG0 | 95 | 750 | 0 | 155 | Unsealing |
| MG20 | 95 | 600 | 150 | 155 | Unsealing |
| MG40 | 95 | 450 | 300 | 155 | Unsealing |
| MG60 | 95 | 300 | 450 | 155 | Unsealing |
| MG80 | 95 | 150 | 600 | 155 | Unsealing |

### Example 3

A 20% OPC+80% GGBS shell material aggregate was formed with the starting materials set forth in Table 4; Second step: aggregate fabrication with the following steps: 1) the raw core and shell materials were firstly pre-mixed in the pelletizer (diameter: 100 cm, depth: 25 cm, and tilting angle: 45°) under an uniform rotation (15 rpm) for 2 minutes; 2) Water was sprayed on the materials during the following 15 minutes continuous rotation of the pelletizer; 3) Additional 3 minutes rotation after spraying of water for the further compaction of the pelletized fresh aggregate; 4) the pelletized fresh aggregate was cured at an unsealing condition under room temperature and humidity for 24 h and then carbon dioxide environmental with pressure of 1 Pa and time of 1, 3, 6, 24 hours for further testing. Third step: the performance was evaluated as shown in FIG. 5. The results demonstrate that carbon dioxide-based curing can further improve the crushing strength of the formed aggregates.

TABLE 4
Mix proportion of LHLCSA with 80% GGBS under different curing
conditions/ton

| | Core materials (kg) | Shell material (kg) | | Water | Curing |
|---|---|---|---|---|---|
| Mix | Cenosphere | Cement | GGBS | (kg) | condition |
| MG80 | 95 | 150 | 600 | 155 | Unsealing |
| MG80-1 | 95 | 150 | 600 | 155 | Carbonation |
| MG80-3 | 95 | 150 | 600 | 155 | Carbonation |
| MG80-6 | 95 | 150 | 600 | 155 | Carbonation |

### Carbon Footprint Assessment

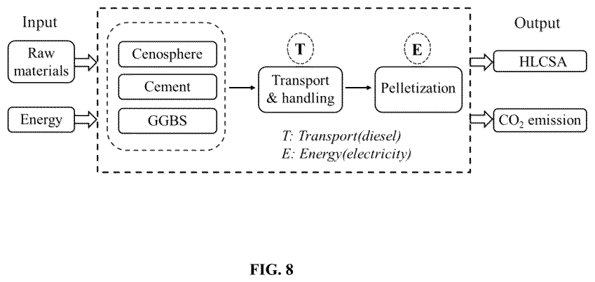

The carbon footprint assessment a) calculates the embodied CO₂ emission (COE) of the formed aggregates; b) compare the COE of the formed aggregates with conventional sintered artificial lightweight aggregates. The scope of the carbon footprint assessment is divided into material manufacturing, transportation, and aggregate production (pelletization), as shown in FIG. 8. Since this carbon footprint assessment was conducted in Hong Kong, China, the relevant data regarding materials, transportation, and processes were sourced locally and referred GB/T 51336-2019, as listed in Tables 5 and 6.

TABLE 5
COE coefficients for materials/processes.

| Materials/ | CO₂ emission | | |
|---|---|---|---|
| Processes | factor | Unit | Reference |
| Cement | 735 | kg CO₂ eq/t | GB/T 51336- |
| | | | 2019 |
| LSC | 8 | kg CO₂ eq/t | ICE V 3.0 |
| GGBS | 83 | kg CO₂ eq/t | ICE V 3.0 |
| Transport, road | 0.078 | kg CO₂ eq/(t · km) (30 t | GB/T 51336- |
| | | truck) | 2019 |
| Transport, sea | 0.015 | kg CO₂ eq/(t · km) | GB/T 51336- |
| | | (2500 t vessel) | 2019 |
| Pelletization | 2.911 | kg CO₂ eq/kw · h | HK Electric |
| | | (4.1 kW pelletizer) | Investment |

Note:
The LSC is regarded as fly ash for carbon footprint assessment.

TABLE 6
Raw materials and the related transport distance.

| Materials | Transport location | Transport type and distance |
|---|---|---|
| Cement | Local cement plant to | 38 km by 30 t trucks |
| | manufacturing site | |
| LSC | Guangdong, China to | 128 km by Inland barge, and |
| | manufacturing site | 21 km by 30 t trucks |
| GGBS | Guangdong, China to | 128 km by Inland barge, and |
| | manufacturing site | 21 km by 30 t trucks |

Since the carbon emission factors of GGBS, FA, expanded perlite, sintered clay, and expanded shale cannot be found from GB/T 51336-2019, they were sourced from Inventory of Carbon & Energy 3.0 (ICE V 3.0). 1 ton of the CSA was considered as afunctional unit. For the input and output flow, energy consumption of diesel during transport and electricity during on-site pelletization were considered. Since water producing very limited carbon emission, its COE was not included.

### Calculation of CO₂ emission

The COE of CSA production was calculated as follows:

$${SUM}_{ce} = \text{?} + {T}_{ce} + \text{?} \qquad ( 2 )$$

$${M}_{ce} = \text{?} {Cef}_{mi} {M}_{i} \qquad ( 3 )$$

$$\text{?} = \text{?} {Cef}_{ti} {T}_{i} \qquad ( 4 )$$

$${P}_{ce} = \text{?} Ce \text{?} {P}_{i} \qquad ( 5 )$$

$$\text{?} \text{indicates text missing or illegible when filed}$$

where SUMce, Mce, Tce, and Pce are the total COE, materials COE, transport COE, and pelletization COE for producing one functional unit of the formed aggregates. Cefmi, and Mi are the materials COE coefficients and consuming contents for producing one functional unit of the formed aggregates. Cefti, and Ti are the transport COE coefficients and transporting contents for producing one functional unit of the formed aggregates. Cefpi, and Pi are the COE coefficients of the pelletizer and pelletizing time for producing one functional unit of the formed aggregates. In this example, the pelletizer power was 4.1 kW, and each round of pelletization takes 20 min with 40 kg of the aggregate production. According to HK Electric Investment, the carbon emission factor of electric consumption was 0.71 kg/kw·h. Other COE coefficients related to materials and processes are listed in Table 5. Raw materials and the related transport distance based on local sources are listed in Table 6.

Results of CO₂ Emission and Competitive Analysis

As shown in FIG. 5, the materials-related COE for the aggregate production was much higher than transport COE and pelletization COE. Taking MO as an example, the materials COE accounted for 95.4% of the total COE. Even for MS80, with the least ratio of materials COE, this ratio was also up to 86.4%. Comparatively, the pelletization COE for M0-MS80 only ranged from 4.2% to 11.9% of the total COE, which proved the green feature of cold-bonding technology in producing the formed aggregates. Since cement has much higher embodied COE than GGBS, the cumulative COE for producing one ton of CSA decreased with the increase of replacing ratio of GGBS to cement, which fell from 578.9 kgCO₂ eq/t for MO to188.1 kgCO₂ eq/t for MS80. As listed in Table 7, by comparing the COE of the formed aggregates with the common commercial lightweight aggregates, it shows that the formed aggregates prepared with 80% GGBS+20% OPC by coldbonding LSC has much lower COE than the conventional sintered aggregates.

TABLE 7

| | Expended | Sintered | Expanded | |
|---|---|---|---|---|
| Key Criteria | perlite | clay | shale | LHALA |
| Loose bulk density | 80.5 | 316 | 607 | 843 |
| (kg/m³) | | | | |
| Crushing strength | 0.135 | 1.132 | 3.291 | 7.68 |
| (MPa) | | | | |
| 24 h water absorption | 286 | 17.8 | 10.2 | 17.8 |
| (% by mass) | | | | |
| Strength efficiency | 1677 | 3582 | 5422 | 9110 |
| (Pa · m³/kg) | | | | |
| CO₂ emission (kgCO₂ | 520 | 393 | 393 | 188 |
| eq/t) | | | | |

Therefore, the formed aggregates can be regarded as low carbon aggregates. Since the aggregates attained different LBD and CS, the strength efficiency (ratio of CS/LBD) was utilized for performance comparison, and the result showed that the developed aggregates with 80% GGBS obtained much higher strength efficiency, indicating it obtained lightweight and high strength features at the same time because of its designed core-shell structure. Thus, the developed aggregates of 80% GGBS CSA can be utilized to produce high-strength lightweight concrete for cost-effective and energy-efficient building construction, which shows to be promising in contributing to the S&G sustainability and carbon neutrality.

### Lightweight Concrete Including Core-Shell Aggregates:

As seen in FIG. 2, lightweight concrete may be formed using the high-strength, lightweight core-shell aggregates of FIG. 1. Depending on the selected amounts of aggregates, the lightweight concrete can achieve a density of 1900 kg/m³ or less, that is, the density point for forming lightweight concrete. This density may be attained by replacing 50% of the natural aggregate with the engineered lightweight aggregate of the present invention. Further reduction in density can be achieved with a higher replacement ratio. However, any replacement percentage may be used with the aggregates of the present invention between 0 and 100% replacement of conventional aggregate in the formed concrete.

It should be noted that the above-mentioned embodiments are only for illustrating the technical solutions of the present invention and not for limiting, and although the present invention has been described in detail with reference to the further embodiments, it should be understood by those skilled in the art that modifications or equivalent substitutions may be made on the technical solutions of the present invention without departing from the spirit and scope of the technical solutions of the present invention, which should be covered by the claims of the present invention.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. The term “substantially coplanar” may refer to two surfaces within a few micrometers (um) positioned along the same plane, for example, within 10 μm, within 5 μm, within 1 μm, or within 0.5 μm located along the same plane. When reference is made to “substantially” the same numerical value or characteristic, the term may refer to a value within ±10%, ±5%, ±1%, or ±0.5% of the average of the values.

Claims:

1. High-strength, lightweight core-shell aggregates from waste materials comprising:
porous core materials selected from large size cenospheres having a size of approximately
1.18 mm to 4.75 mm;
at least one layer of shell material formed on the porous core materials by cold bonding, the at least one layer of shell material including one or more of GGBS, fly ash, recycled concrete powder, recycled glass powder, OPC, or biochar powder;
where the high-strength, lightweight core-shell aggregates have a loose bulk density less than approximately 980 kg/m³, a crushing strength higher than approximately 4 MPa, a water absorption of less than 20%, and a carbon emission of approximately 181 kgCO₂eq/t or less.

2. The high-strength, lightweight core-shell aggregates from waste materials of claim 1, further comprising a second layer of shell material selected from one or more of GGBS, fly ash, recycled concrete powder, recycled glass powder, OPC, or biochar powder.

3. The high-strength, lightweight core-shell aggregates from waste materials of claim 1, wherein the aggregate size ranges from approximately 2.36 mm to 30 mm.

4. The high-strength, lightweight core-shell aggregates from waste materials of claim 1, wherein the aggregates have been strengthened by one or more of hydration, geopolymerization or carbonization.

5. Lightweight concrete including the high-strength, lightweight core-shell aggregates from waste materials of claim 1, the lightweight concrete having a density of 1900 kg/m³ or less.

6. A method of making the high-strength, lightweight core-shell aggregates from waste materials of claim 1, comprising:
providing porous core materials selected from one or more of perlite, vermiculite, cenospheres, expanded polystyrene, or biochar;
adding one or more shell materials selected from one or more of GGBS, fly ash, recycled concrete powder, recycled glass powder, OPC, or biochar powder to the core materials;
mixing the porous core materials and the shell materials through rotation in a pelletizer;
adding a hydrating material selected from one or more of water, water glass, or aqueous alkali to form hydrated, pelletized, core-shell aggregates.

7. The method of claim 6, further comprising curing the hydrated pelletized core-shell aggregates.

8. The method of claim 6, further comprising forming a second shell layer from one or more of GGBS, fly ash, recycled concrete powder, recycled glass powder, OPC, or biochar.

9. The method of claim 7, wherein the curing is performed in carbon dioxide-rich atmosphere.

10. The method of claim 6, wherein the hydrating material is added to the core material prior to adding the shell material.
